(19) United States
(12) Patent Application Publication
(10) Pub. No.: US 2005/0289132 A1
(43) Pub. Date: Dec. 29, 2005

(54) Method and system for converting encoding character set

(76) Inventor: Brian Lee, Hsinchu City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/876,078

(22) Filed: Jun. 24, 2004

(51) Int. Cl. G06F 17/30

(52) U.S. Cl. 707/4

(57) ABSTRACT

A character conversion method for converting an encoding character set of characters from a source character set to a destination character set. Characters are first provided, each encoded in first character codes according to the source character. An intermediate character set is then selected. The characters are encoded in the same first character codes according to the intermediate character set and the destination character set is a strict superset of the intermediate character set. Next, the encoding character set of the characters is first converted from the source character set to the intermediate character set and then converted from the intermediate character set to the destination character set. Each character is encoded in second character codes according to the destination character set after the conversion.

### BACKGROUND

The present invention relates to character conversion technology, and in particular to a method for converting an encoding character set.

In data processing, data is distributed to different data storage devices or data operating devices, such as databases or computers, requiring data manipulation, such as data selection, deletion, or integration, all across different databases. Usually, each database adopts a certain character set for encoding data stored therein.

If different databases adopt the same character set, characters can be manipulated directly among databases. Additionally, if one character is encoded in the same character code for two different character sets applied in different databases, direct character manipulation is also enabled.

Conventionally, alphanumeric characters work well with character conversion because the characters are encoded with the same character codes even in different character sets. Character conversion problems occur, however, with non-Roman characters, such as Chinese or other Asian languages. Each database may adopt a different character set to encode these characters, and these character sets are incompatible.

Recently, many databases have adopted Unicode as a character set for encoding stored data because of its ability to display multiple languages, including Chinese, and scripts within the same documents. Thus, characters are frequently converted from a database to another for database transfer, causing character conversion problems.

For example, a source database adopts an ASCII character set and a destination database adopts UTF-8 character set for encoding. Chinese characters, while not elements of the ASCII character set, may still be encoded in an ASCII-compatible character set, such as BIG5, for storage in the source database. For the destination character set, Chinese characters can be encoded and stored because they are elements of UTF-8. However, the character codes for Chinese characters in the source and destination databases are different. If Chinese characters are to be manipulated between the two databases, character conversion problems occur.

Some database systems provide solutions for character conversion. The solutions usually focus on database transfer issues but not on non-Roman character issues, as those with Chinese, Japanese, or Korean characters.

### SUMMARY

Accordingly, an object of the invention is to provide a method for characters encoding resolving conversion problems, especially for non-alphanumeric characters. Another object is to provide improved data manipulation among different databases.

To achieve the foregoing objects, the invention provides a computer implemented method for converting an encoding set of characters from a source character set to a destination character set. The destination character set is not a strict superset of the source character set. The method first obtains the characters, each of which is encoded in first character codes according to the source character set. The method then selects an intermediate character set. The characters are encoded in the same first character codes according to the intermediate character set. The destination character set is a strict superset of the intermediate character set. Next, the method converts the encoding character set of the characters firstly from the source character set to the intermediate character set. Finally, the method converts the encoding character set of the characters secondly from the intermediate character set to the destination character set. Each character is encoded in second character codes according to the destination character set after the conversion.

### BRIEF DESCRIPTION OF THE DRAWINGS

The present invention can be more fully understood by reading the subsequent detailed description and examples with references made to the accompanying drawings, wherein:

FIG. 1 is a diagram of the relationship between source, intermediate, and destination character sets.

FIG. 2 is a flowchart of the conversion method.

FIG. 3 is a diagram of the conversion system according to one embodiment of the present invention.

FIG. 4 is a diagram of the conversion system according to another embodiment of the present invention.

### DESCRIPTION

As summarized above, the present invention provides a computer implemented method for converting an encoding character set of characters from a source character set, such as US7ASCII, to a destination character set, such as UTF-8. The destination character set is not a strict superset of the source character set.

The method first obtains the characters, each of which is encoded in first character codes according to the source character set. The method then selects an intermediate character set. The characters are encoded in the same first character codes according to the intermediate character set and the destination character set is a strict superset of the intermediate character set.

Next, the method converts the encoding character set of the characters firstly from the source character set to the intermediate character set. Finally, the method converts the encoding character set of the characters secondly from the intermediate character set to the destination character set. Each character is encoded in second character codes according to the destination character set after the conversion.

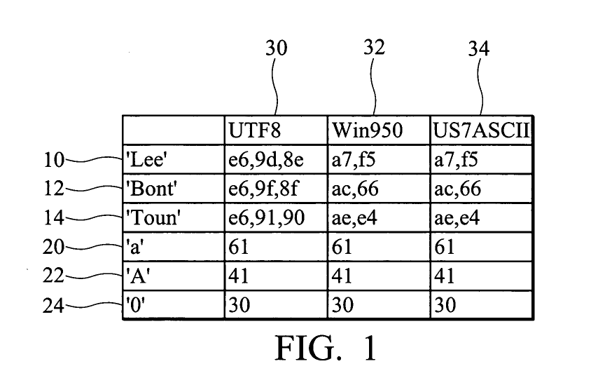

FIG. 1 is a diagram of the relationship between source, intermediate, and destination character sets. Chinese characters 10 ‘Lee’, 12 ‘Bont’, and 14 ‘Toun’ are encoded in character codes as (a7, f5), (ac, 66), and (ae, e4) respectively according to an US7ASCII compatible character set.

WIN950 is selected as an intermediate character set because Chinese characters are encoded therein in the same character codes as the US7ASCII compatible character set. The characters 10 ‘Lee’, 12 ‘Bont’, and 14 ‘Toun’ are elements of WIN950. The character codes can be mapped directly from WIN950 to UTF-8 because UTF-8 is a strict superset of WIN950.

The first conversion from US7ASCII to WIN950 can be accomplished by attaching a flag, since character codes are the same. The flag is an environment variable labeling the encoding character set of the characters although the character codes are the same as the source character set.

The encoding length of the characters must be altered for the second conversion from WIN950 to UTF-8. The encoding length of the character codes of the characters is increased by 50% of thr original because Chinese characters are usually encoded in three bytes in UTF-8 but two bytes in US7ASCII or WIN950.

The characters can be stored in databases. The stored characters can be recorded to a file and converted therefrom. The recorded characters can be output to a database after the conversions. Thus, the inventive method can convert characters between two different databases with different character sets through recorded files.

The two-phase character conversion is applicable when characters encoded in a source character set and a destination character set cannot be converted directly, and an intermediate character set can then be applied as an interface. A character conversion can be executed directly only if the destination character set is a strict superset of the source character set, since, otherwise, data may be lost.

Importantly, there are critical conditions for selecting the intermediate character set. Above all, the characters must be encoded in the same character codes according to the intermediate character set as the source character set. Moreover, the destination character set must be a strict superset of the intermediate character set.

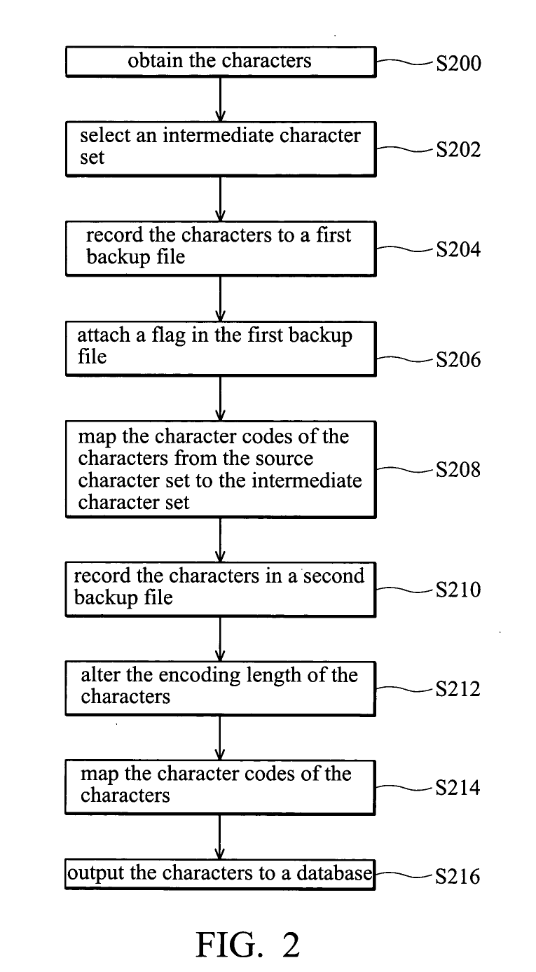

FIG. 2 is a flowchart of the conversion method. In one embodiment, the characters are first obtained (step S200). The characters can be obtained from a database. Each character is encoded in first character codes according to the source character set.

An intermediate character set is then selected (step S202) The characters are encoded in the same first character codes according to the intermediate character set. The destination character set is a strict superset of the intermediate character set.

The encoding character set of the characters is converted firstly from the source character set to the intermediate character set. The characters are recorded to a first backup file (step S204). A flag is attached in the first backup file (step S206). The flag is an environmental variable. The character codes of the characters in the first backup file are mapped from the source character set to the intermediate character set according to the flag (step S208).

The encoding character set of the characters is converted secondly from the intermediate character set to the destination character set. The characters are recorded in a second backup file (step S210). The encoding length of the characters is altered in the second backup file (step S212). The character codes of the characters in the second backup file are mapped from the intermediate character set to the destination character set (step S214). Each character is encoded in second character codes according to the destination character set after the conversion. The characters can be output to a database after the second conversion (step S216).

Moreover, the present invention provides a system for converting an encoding character set of characters from a source character set to a destination character set. The destination character set is not a strict superset of the source character set. The inventive system comprises a source database, a destination database, and a converter.

The source database stores the characters, each of which is encoded in first character codes according to the source character set. The destination database stores the characters. In the destination database, each character is encoded in second character codes according to the destination character set. A converter is coupled to the source database and the destination database. The converter selects an intermediate character set, converts the encoding character set of the characters firstly from the source character set to the intermediate character set, and converts the encoding character set of the characters secondly from the intermediate character set to the destination character set.

The characters are encoded in the first character codes according to the intermediate character set as the source character set and the destination character set is a strict superset of the intermediate character set.

For the first conversion, the converter further records the characters to a first backup file, attaches a flag in the first backup file, and maps character codes of the characters in the first backup file from the source character set to the intermediate character set according to the flag. The flag is an environmental variable.

For the second conversion, the converter further records the characters in a second backup file, alters the encoding length of the characters in the second backup file, and maps character codes of the characters in the second backup file from the intermediate character set to the destination character set.

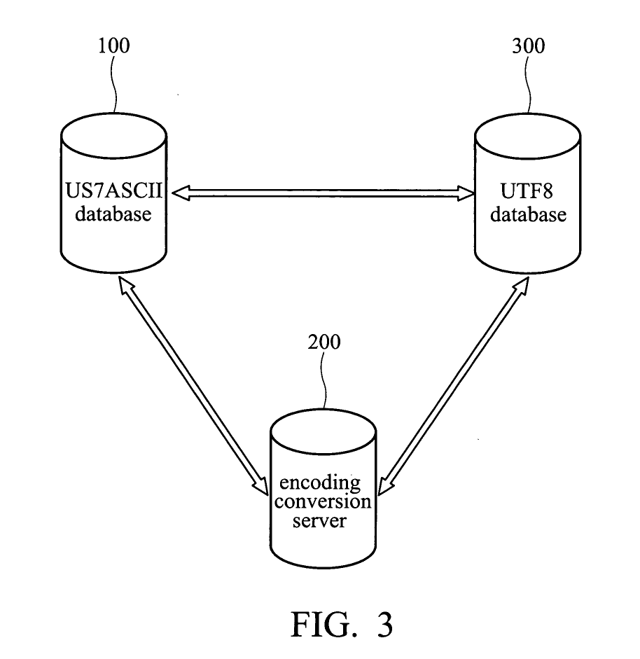

FIG. 3 is a diagram of the conversion system according to one embodiment of the present invention. In this embodiment, the system comprises a source database 100, a destination database 300, and a converter 200. The source database 100 and the destination database 300 can be installed in client computers. The converter 200 can be implemented as a server.

In the embodiment, the source database 100 provides characters encoded in first character codes according to a source character set, for example, US7ASCII. The destination database 300 stores characters encoded in second characters codes according to a destination character set, For example, UTF-8.

The converter 200 is coupled to the source database 100 and the destination database 300. The converter 200 selects an intermediate character set, for example, WIN950, converts the encoding character set of the characters firstly from US7ASCII to WIN950, and then converts the encoding character set of the characters secondly from WIN950 to UTF-8.

For the first conversion, the converter 200 records the characters to a first backup file, attaches a flag in the first backup file, and maps character codes of the characters in the first backup file from US7ASCII to WIN950 according to the flag. The flag is an environmental variable to label the encoding character set.

For the second conversion, the converter 200 records the characters in a second backup file, alters the encoding length of the characters in the second backup file. In the embodiment, the encoding length is increased by 50% of the original because the encoding length of UTF-8 is 1.5 times to WIN950. The converter 200 then maps character codes of the characters in the second backup file from WIN950 to UTF-8.

Thus, the data stored in the source database 100 can be converted to the destination database 300 through the intermediate character set.

Furthermore, a system for converting an encoding character set of characters from a source character set to a destination character set is provided. The destination character set is not a strict superset of the source character set. The conversion system comprises a converter.

The converter selects an intermediate character set, converts an encoding character set of a plurality of characters firstly from the source character set to the intermediate character set, and converts the encoding character set of the characters secondly from the intermediate character set to the destination character set. The characters are encoded in first character codes according to the intermediate character set as the source character set and the destination character set is a strict superset of the intermediate character set.

For example, the source character set may be US7ASCII character set, the intermediate character set may be WIN950 character set, and the destination character set may be UTF-8 character set.

For the first conversion, the converter records the characters to a first backup file, attaches a flag in the first backup file, and maps character codes of the characters in the first backup file from the source character set to the intermediate character set according to the flag. The flag is an environmental variable.

For the second conversion, the converter records the characters in a second backup file, alters the encoding length of the characters in the second backup file, and maps character codes of the characters in the second backup file from the intermediate character set to the destination character set. The characters can be stored in databases.

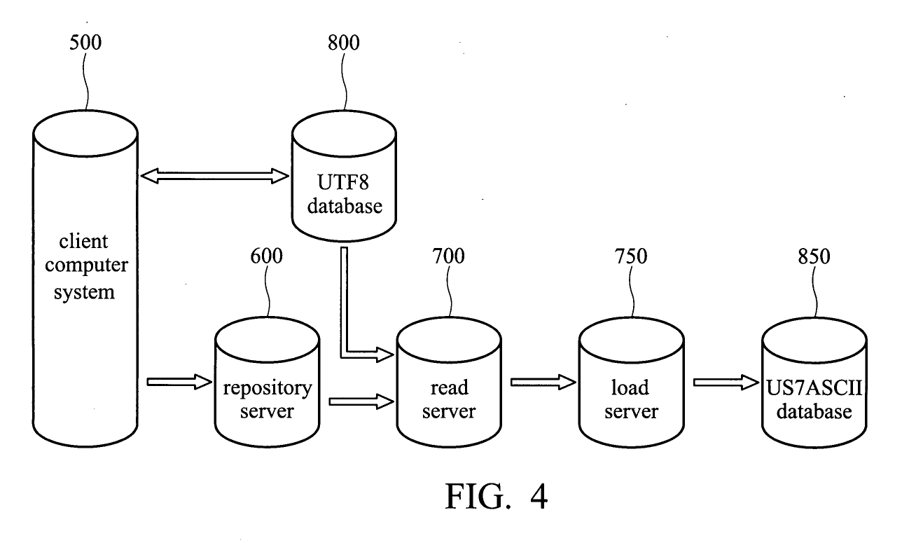

FIG. 4 is a diagram of the conversion system according to another embodiment of the present invention. As an example, the system comprises a client computer system 500, a repository server 600, a read server 700, a load server 750, an UTF8 database 800, and an US7ASCII database 850. The US7ASCII database 850 comprises characters to be converted.

The client computer system 500 accesses the UTF-8 database 800 by ODBC (Open Database Connectivity). The client computer system 500 utilizes data workflow for data extraction and loading. The client computer system 500 executes and monitors the data workflow, i.e. read, send, and load commands to the repository server 600. The repository server 600 is connected to the client computer system 500, storing programs corresponding to the commands of the data workflow.

The load server 750 is connected to the US7ASCII database 850 to load the characters and converts the encoding character set of the characters firstly from the source character set to the intermediate character set, that is, from US7ASCII to WIN950. The UTF-8 database 800 reads the firstly converted characters through the read server 700 and converts the character set of the characters secondly from the intermediate character set to the destination character set, that is, from WIN950 to UTF-8. Thus, the character conversion is accomplished.

Thus, method and systems of character conversion are disclosed. The disclosed method and systems can be applied to other database systems to resolve character conversion problems.

It will be appreciated from the foregoing description that the method and system described herein provide a dynamic and robust solution to character conversion problems for a database system. If, for example, the database system changes the encoding character set, the method and system of the present invention can be revised accordingly.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A computer implemented method for converting an encoding character set of characters from a source character set to a destination character set, wherein the destination character set is not a strict superset of the source character set, comprising the steps of:
providing a plurality of characters, each character encoded in a plurality of first character codes according to the source character set;
selecting an intermediate character set, the characters encoded in the same first character codes according to the intermediate character set and the destination character set is a strict superset of the intermediate character set;
converting the encoding character set of the characters firstly from the source character set to the intermediate character set; and
converting the encoding character set of the characters secondly from the intermediate character set to the destination character set, wherein each character is encoded in a plurality of second character codes according to the destination character set after the conversion.

2. The computer implemented method of claim 1, wherein the source character set is a US7ASCII character set, the intermediate character set is a WIN950 character set, and the destination character set is a UTF-8 character set.

3. The computer implemented method of claim 1, wherein the first conversion further comprises the steps of:
recording the characters to a first backup file;
attaching a flag in the first backup file; and
mapping character codes of the characters in the first backup file from the source character set to the intermediate character set according to the flag.

4. The computer implemented method of claim 3, wherein the flag is an environmental variable.

5. The computer implemented method of claim 3, wherein the second conversion further comprises the steps of:
recording the characters in a second backup file;
altering an encoding length of the characters in the second backup file; and
mapping character codes of the characters in the second backup file from the intermediate character set to the destination character set.

6. The computer implemented method of claim 3, further comprising outputting the characters in the second backup file to a destination database which adopts the destination character set as an encoding character set.

7. The computer implemented method of claim 1, wherein the plurality of characters are provided from a source database which adopts the source character set as an encoding character set.

8. A system for converting an encoding character set of characters from a source character set to a destination character set, wherein the destination character set is not a strict superset of the source character set, comprising:
a source database, storing a plurality of characters, each character encoded in a plurality of first character codes according to the source character set;
a destination database, storing the characters, each character encoded in a plurality of second character codes according to the destination character set; and
a converter, coupled to the source database and the destination database, selecting an intermediate character set, converting the encoding character set of the characters firstly from the source character set to the intermediate character set, and converting the encoding character set of the characters secondly from the intermediate character set to the destination character set, wherein the characters are encoded in the first character codes according to the intermediate character set as the source character set and the destination character set is a strict superset of the intermediate character set.

9. The system of claim 8, wherein the source character set is a US7ASCII character set, the intermediate character set is a WIN950 character set, and the destination character set is a UTF-8 character set.

10. The system of claim 8, the converter further recording the characters to a first backup file, attaching a flag in the first backup file, and mapping character codes of the characters in the first backup file from the source character set to the intermediate character set according to the flag.

11. The system of claim 10, wherein the flag is an environmental variable.

12. The system of claim 8, wherein the converter further recording the characters in a second backup file, altering the encoding length of the characters in the second backup file, and mapping character codes of the characters in the second backup file from the intermediate character set to the destination character set.

13. A system for converting an encoding character set of characters from a source character set to a destination character set, wherein the destination character set is not a strict superset of the source character set, comprising:
a converter, selecting an intermediate character set, converting an encoding character set of a plurality of characters firstly from the source character set to the intermediate character set, and converting the encoding character set of the characters secondly from the intermediate character set to the destination character set, wherein the characters are encoded in first character codes according to the intermediate character set as the source character set and the destination character set is a strict superset of the intermediate character set.

14. The system of claim 13, wherein the source character set is a US7ASCII character set, the intermediate character set is a WIN950 character set, and the destination character set is a UTF-8 character set.

15. The system of claim 13, wherein the converter further recording the characters to a first backup file, attaching a flag in the first backup file, and mapping character codes of the characters in the first backup file from the source character set to the intermediate character set according to the flag.

16. The system of claim 15, wherein the flag is an environmental variable.

17. The system of claim 13, the converter further recording the characters in a second backup file, altering the encoding length of the characters in the second backup file, and mapping character codes of the characters in the second backup file from the intermediate character set to the destination character set.

18. The system of claim 13, wherein the characters are stored in a database.
